(19) United States
(12) Patent Application Publication
(10) Pub. No.: US 2004/0038188 A1
(43) Pub. Date: Feb. 26, 2004

(54) Speech selfstudy mate

(76) Inventor: Gun Woo Lee, Seoul (KR)

Correspondence Address: LADAS & PARRY, 224 SOUTH MICHIGAN AVENUE, SUITE 1200, CHICAGO, IL, 60604, US

(21) Appl. No.: 10/633,430

(22) Filed: Aug. 1, 2003

(30) Foreign Application Priority Data
Aug. 26, 2002 (KR) 20-2002-0025343

(51) Int. Cl. G09B 19/04

(52) U.S. Cl. 434/185

(57) ABSTRACT

Disclosed herein is a speech training device which can be put on the mouth and on the face around the mouth of a user of the speech training device for directly transmitting a sound pronounced by the user of the speech training device to the ears of the user so that speech training is efficiently performed. The speech training device comprises a resonance chamber making contact with the mouth of the user of the speech training device, a sound transmitting tube including right and left sound transmitting tube parts connected to the resonance chamber, shape-adjusting corrugations partially formed at the inner and outer sides of the sound transmitting tube between the resonance chamber and the ends of the sound transmitting tubes, and sound outlets formed at both ends of the sound transmitting tubes, which makes contact with the ears of the user of the speech training device, whereby a resonant sound in the resonance chamber is directly transmitted to the ears of the user of the speech training device along the sound transmitting tubes.

### BACKGROUND OF THE INVENTION

1. Field of the Invention

The present invention relates to the speech training device, and more particularly to the speech training device comprising: a resonance chamber with a prescribed volume having a sound inlet formed at the rear part thereof; a sound transmitting tube including right and left sound transmitting tube parts connected to the resonance chamber, the right and left sound transmitting tube parts each having a prescribed length so that the right and left sound transmitting tube parts make contact with the cheeks of the user; shape-adjusting corrugations partially formed at the inner and outer sides of the sound transmitting tube between the resonance chamber and the ends of the sound transmitting tube; sound outlets formed at both ends of the sound transmitting tube, which make contact with the user's ears; ear-hangers attached to the insides of the sound outlets so that the ear-hangers are hung on the user's ears; and a nose-hanger attached to the sound transmitting tube, so that a sound pronounced by the user resonates in the resonance chamber, and the resonant sound is directly transmitted to the ears of the users along the sound transmitting tube, thereby improving speech training efficiency.

2. Description of the Prior Art

When drills of pronunciation, public speeches, directions of meetings, lectures, foreign languages, songs, dialogs for performances, preachings, etc., are performed, it is difficult to perform an efficient drill without interfering with other's activities. Specifically, sounds pronounced by the driller are transmitted to those around the driller, and the pronounced sound are not clearly and accurately transmitted to the driller's ears due to external sound and noise.

### SUMMARY OF THE INVENTION

Therefore, the present invention has been made in view of the above problems, and it is an object of the present invention to provide a speech training device comprising: a resonance chamber with a prescribed volume having a sound inlet formed at the rear part thereof; a sound transmitting tube connected to the resonance chamber in such a manner that the sound transmitting tube makes contact with the cheeks to the ears of a user of the speech training device; shape-adjusting corrugations partially formed at the sides of the sound transmitting tube between the resonance chamber and the ends of the sound transmitting tube for easily adjusting the distance between the ends of the right and left sound transmitting tube parts of the sound transmitting tube; ear-hangers attached to the sound transmitting tube; and a nose-hanger attached to the sound transmitting tube for preventing separation of the speech training device from the face of the user of the speech training device, so that a sound pronounced by the user of the speech training device resonates in the resonance chamber, and the resonant sound is clearly and accurately transmitted to the ears of the user of the speech training device along the sound transmitting tube, thereby improving speech training efficiency.

In accordance with the present invention, the above and other objects can be accomplished by the provision of a speech training device generally formed in the shape of a “U”, comprising: a resonance chamber having a sound inlet formed at the rear part thereof, the sound inlet making contact with the mouth of a user of the speech training device so that a sound pronounced by the user of the speech training device is introduced into the resonance chamber through the sound inlet; a sound transmitting tube for transmitting the pronounced sound, the sound transmitting tube including right and left sound transmitting tube parts connected to the resonance chamber so that the right and left sound transmitting tube parts communicate with the resonance chamber, each of the right and left sound transmitting tube parts having a prescribed length; sound outlets formed at both ends of the sound transmitting tube for sending out the sound transmitted along the sound transmitting tube; ear-hangers attached to the insides of the sound outlets so that the ear-hangers are put on the ears of the user of the speech training device, the ear-hanger being made of an elastic material; and shape-adjusting corrugations partially formed at the inner and outer sides of the sound transmitting tubes between the resonance chamber and the ends of the sound transmitting tubes for adjusting the distance between the ends of the sound transmitting tubes so that the speech training device makes close contact with the face of the user of the sound transmitting tubes at the inner side of the sound transmitting tube.

Preferably, the speech training device of the present invention further comprises a nose-hanger having hooks formed at both ends thereof, and the sound transmitting tubes have pins formed at the right and left sound transmitting tube parts of the sound transmitting tube. The hooks are engaged with the pins, respectively, so that separation of the speech training device of the present invention from the user's face is prevented.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a speech training device of the present invention;

FIG. 2 is an exploded perspective view of a speech training device of the present invention;

FIG. 3 is a side view of a speech training device showing the speech training device positioned on the face of a user of the speech training device;

FIG. 4 is a plan view, in cross section, of a speech training device of the present invention;

FIG. 5a is a cross-sectional view taken along line A-A of FIG. 4; and

FIG. 5b is a cross-sectional view taken along line B-B of FIG. 4.

### DETAILED DESCRIPTION

Now, a preferred embodiment of the present invention will be described in detail with reference to the accompanying drawings.

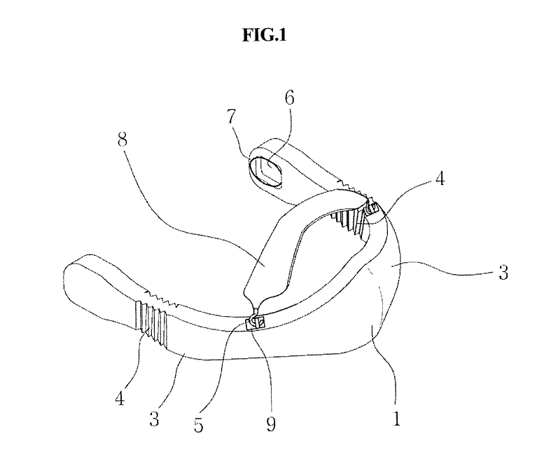

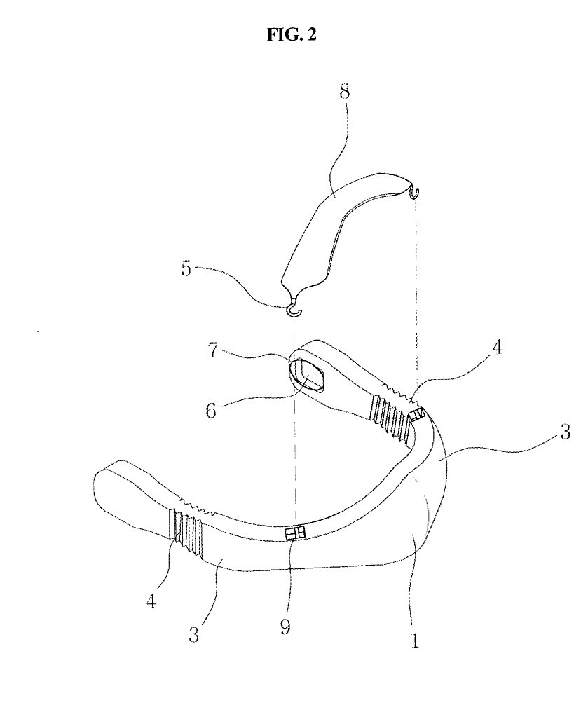

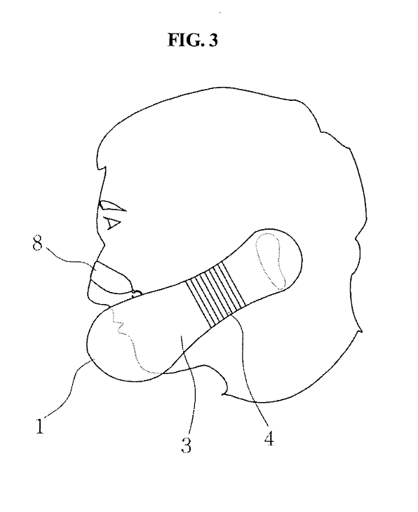

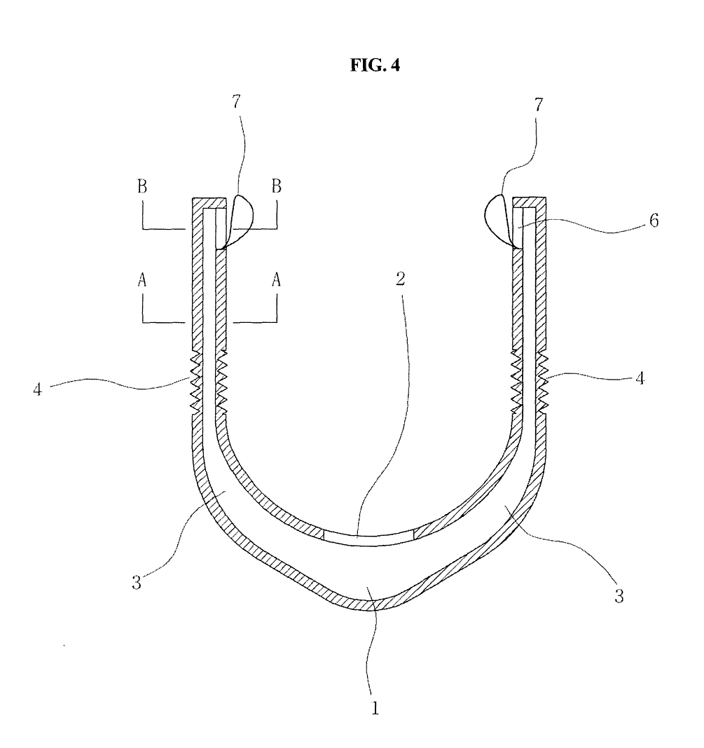

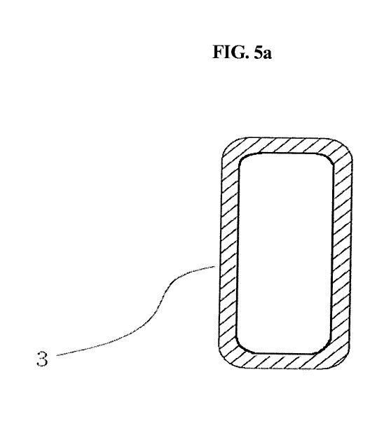

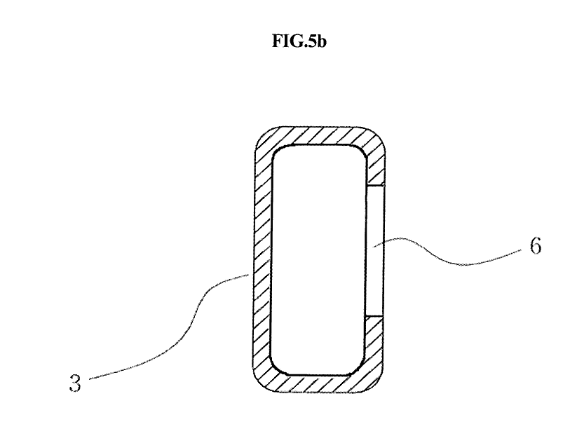

FIG. 1 is a perspective view of a speech training device of the present invention, FIG. 2 is an exploded perspective view of a speech training device of the present invention, FIG. 3 is a side view of a speech training device showing the speech training device positioned on the face of a user of the speech training device, FIG. 4 is a plan view, in cross section, of a speech training device of the present invention, FIG. 5a is a cross-sectional view taken along line A-A of FIG. 4, and FIG. 5b is a cross-sectional view taken along line B-B of FIG. 4.

The speech training device of the present invention is preferably made of an elastic material so that the length of the speech training device is easily adjustable on the basis of the shape of the head of the users.

As shown in FIG. 4, the speech training device of the present invention is generally made up of a face contacting part, which is a hollow member approximately formed in the shape of a “U”, and ear contacting parts integrally formed with the face contacting part. Each of the ear contacting parts is a straight hollow member. Since the face contacting part is formed in the shape of the “U” as described above, the face contacting part of the speech training device can make easy and comfortable contact, at the inner side thereof, with the face of the users. The ear contacting parts are extended from the face contacting part so that the free ends of the ear contacting parts reach to the user's ears when he/she puts the speech training device on his/her face. Inside the hollow face contacting part and the hollow ear contacting parts is defined sounds transmitting tubes 3.

At the inner side of the face contacting part of the speech training device, which makes contact with the user's mouth, is formed a sound inlet 2. The sound inlet 2 communicates with the sound transmitting tubes 3. The middle part of the sound transmitting tubes 3, which is placed in the front of the the user's mouth when he/she puts the speech training device on his/her face, has a larger length than the remaining parts of the sound transmitting tubes 3. The middle part of the sound transmitting tubes 3 placed in front of the mouth of the user of the speech training device serves as a resonance chamber 1 in which the sound introduced through the sound inlet 2 sufficiently resonates. At the inner and outer sides of the sound transmitting tubes 3 between the resonance chamber 1 and the free ends of the ear contacting parts are partially formed shape-adjusting corrugations 4, by which the distance between the free ends of the ear contacting parts of the speech training device can be easily adjusted.

At the inner sides of the ear contacting parts of the speech training device, which are close to the free ends of the ear contacting parts, are formed sound outlets 6, which make contact with the the user's ears. To the insides of the sound outlets 6 are attached ear-hangers 7, which are hung on the ears of the user of the speech training device so that the speech training device of the present invention is securely positioned on the face of the user. The speech training device of the present invention further comprises a nose-hanger 8, which is put on the nose of the user of the speech training device for preventing separation of the speech training device from the user's face. The nose-hanger 8 is preferably made of a material which can make positive contact with the nose of the user of the speech training device.

As described above, the resonance chamber 1 is formed in the vicinity of the sound inlet 2, which makes contact with the mouth of the user of the speech training device, in the face contacting part of the speech training device. A sound pronounced from the user's mouth and the nose is directly introduced into the resonance chamber 1 through the sound inlet 2. The introduced sound resonates in the resonance chamber 1, and is then transmitted toward the sound outlets 6 along the sound transmitting tubes 3. The resonance chamber 1 has sufficient volume so that the sound effectively resonates in the resonance chamber 1. In addition, the resonance chamber 1 has a bilaterally symmetrical structure so that the resonant sound is accurately transmitted toward the sound outlets 6 along the right and left parts of the sound transmitting tubes 3.

To both sides of the resonance chamber 1 are integrally connected the right and left parts of the sound transmitting tubes 3 in such a manner that the resonance chamber communicates with the right and left parts of the sound transmitting tubes 3. The sound transmitting tubes 3 makes contact with the face of the speech training device from the cheeks to the user's ears.

Consequently, the resonant sound in the resonance chamber 1 is accurately transmitted toward the sound outlets 6 along the right and left parts of the sound transmitting tubes 3.

At the positions where the face contact part is connected with the ear contact parts are formed the shape-adjusting corrugations 4, each of which has a prescribed length. The speech training device of the present invention is flexible by the provision of the shape-adjusting corrugations 4. Specifically, the shape of the sound transmitting tubes 3 can be easily changed depending upon the face shape of the user of the speech training device by virtue of the shape-adjusting corrugations 4 so that the speech training device of the present invention can be easily positioned on the face of the user of the speech training device irrespective of the face shape of the user of the speech training device.

At the ends of the sound transmitting tubes 3 are formed the sound outlets 6, which make contact with the user's ears. To the insides of the sound outlets 6 are attached ear-hangers 7 made of an elastic material, which are hung on the ears of the user of the speech training device so that the speech training device of the present invention is securely positioned on the face of the user of the speech training device. The sound passing along the sound transmitting tubes 3 is directly transmitted into the ears of the user of the speech training device through the sound outlets 6. The ears of the user of the speech training device make contact with the sound outlets 6, and the ear-hangers 7 are hung on the ears of the user of the speech training device so that the speech training device of the present invention is securely positioned on the face of the user of the speech training device.

To prevent separation of the speech training device of the present invention from the face of the user of the speech training device, both ends of the nose-hanger 8 having a prescribed length are attached, at prescribed points, to the right and left parts of the sound transmitting tubes 3, respectively. The nose-hanger 8 is put on the nose of the user of the device for supporting the device so that separation of the device of the present invention from the face of the user is prevented. At the both ends of the nose-hanger 8 are formed hooks 5, and at the right and left parts of the sound transmitting tubes 3 are formed corresponding pins 9, respectively, so that the nose-hanger 8 can be detachably attached to the sound transmitting tubes 3.

In the speech training device of the present invention, the passage of sound transmission from the sound inlet 2 of the resonance chamber 1 to the sound outlets 6 is isolated from the outside. Consequently, the sound pronounced by the user of the device does not flow out of the speech training device of the present invention nor does any external noise flow into the speech training device of the present invention.

Now, the operation of the speech training device of the present invention with the above-stated construction will be described in detail.

The user of the speech training device puts his/her mouth to the sound inlet 2 formed at the resonance chamber 1 so that the mouth makes contact with the sound inlet 2, and hangs the ear-hangers on his/her ears so that the ears make contact with the sound outlets 6 of the sound transmitting tubes 3. Subsequently, the user puts the nose-hanger 8 attached to the sound transmitting tubes 3 on his/her nose so that separation of the speech training device from the user's face is prevented. In this way, the speech training device of the present invention is put on the lower part of the face of the user. A sound pronounced from the mouth and the nose of the user of device is directly introduced into the resonance chamber 1 through the sound inlet 2. The introduced sound resonates in the resonance chamber 1, and is then transmitted along the right and left parts of the sound transmitting tubes 3. The sound transmitted along the right and left parts of the sound transmitting tubes 3 passes through the shape-adjusting corrugations 4 to the sound outlets 6. As a result, the sound is clearly and accurately transmitted to the ears of the user of the speech training device.

The passage of the pronounced sound transmission is pretty much isolated from the outside. Consequently, the sound pronounced by the user of the speech training device does not flow out of the speech training device of the present invention, whereby speech training using the speech training device of the present invention does not interfere with other's activities. Moreover, much less external noise flows into the speech training device of the present invention, whereby the speech training using the speech training device of the present invention is not affected by the external noise.

As apparent from the above description, the present invention provides a speech training device comprising: a resonance chamber having a sound inlet formed at the rear part thereof, the sound inlet making contact with the mouth of a user of the speech training device so that a sound pronounced by the user of the speech training device is introduced into the resonance chamber through the sound inlet; a sound transmitting tubes connected to the resonance chamber; shape-adjusting corrugations partially formed at the sides of the sound transmitting tube between the resonance chamber and the ends of the sound transmitting tubes; and sound outlets formed at both ends of the sound transmitting tubes, which makes contact with the ears of the user of the speech training device, so that the sound pronounced by the user of the speech training device does not flow out of the speech training device of the present invention nor does any external noise flow into the speech training device of the present invention, whereby the pronounced sound is clearly and accurately transmitted to the ears of the user of the speech training device, and thus speech training efficiency is improved.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A speech training device generally formed in the shape of a “U”, comprising:
a resonance chamber having a sound inlet formed at the rear part thereof, the sound inlet making contact with the mouth of a user of the speech training device so that a sound pronounced by the user of the speech training device is introduced into the resonance chamber through the sound inlet;
a sound transmitting tubes for transmitting the pronounced sound, the sound transmitting tubes including right and left sound transmitting tube parts connected to the resonance chamber so that the right and left sound transmitting tube parts communicate with the resonance chamber, each of the right and left sound transmitting tube parts having a prescribed length;
sound outlets formed at both ends of the sound transmitting tubes for sending out the sound transmitted along the sound transmitting tubes;
ear-hangers attached to the insides of the sound outlets so that the ear-hangers are put on the ears of the user of the speech training device, the ear-hanger being made of an elastic material; and
shape-adjusting corrugations partially formed at the inner and outer sides of the sound transmitting tube between the resonance chamber and the ends of the sound transmitting tubes for adjusting the distance between the ends of the sound transmitting tubes so that the speech training device makes close contact with the face of the user of the sound transmitting tubes at the inner side of the sound transmitting tubes.

2. The device as set forth in claim 1, further comprising a nose-hanger having hooks formed at both ends thereof, wherein the sound transmitting tube has pins formed at the right and left sound transmitting tube parts of the sound transmitting tubes, the hooks being engaged with the pins, respectively, so that separation of the speech training device of the present invention from the face of the user of the speech training device is prevented.
